(19) United States
(12) Patent Application Publication
(10) Pub. No.: US 2003/0147621 A1
(43) Pub. Date: Aug. 7, 2003

(54) Groove waveguide with reduced output divergence

(75) Inventors: Il?apos;ya Agurok, Long Beach, CA (US); Tomasz P. Jannson, Torrance, CA (US)

Correspondence Address: LEONARD TACHNER, A PROFESSIONAL LAW, CORPORATION, 17961 SKY PARK CIRCLE, SUITE 38-E, IRVINE, CA, 92614

(73) Assignee: Physical Optics Corporation

(21) Appl. No.: 10/061,685

(22) Filed: Feb. 1, 2002

(51) Int. Cl. G02B 6/10

(52) U.S. Cl. 385/146; 385/129

(57) ABSTRACT

A waveguide includes a longitudinal structure having a first end opposite a second end. The waveguide further includes a grooved surface formed on the structure adjacent the first end. The geometric size of the longitudinal structure is substantially constant while the grooved surface reshapes a light input ray to decrease the divergence of the ray in the vertical direction and increase the divergence of the ray in the horizontal direction.

### FIELD OF THE INVENTION

The present invention is directed to a light guide, and in particular to a groove-shaped waveguide for shaping light rays.

### BACKGROUND OF THE INVENTION

The prior art primarily uses light guides to transfer light as far as possible. In this regard, one method of guiding light energy is to use a dielectric waveguide that includes a solid rod made of transparent material. The light rays are reflected inward by the surface of the rod (e.g., total internal reflection). Another method of guiding light energy includes having light propagate mainly through air and periodically redirecting the light to keep it confined and traveling in the correct direction.

Conventional waveguides typically include a circular cross-section having an optical lighting film, a back reflector and an outer shell. The back reflector is fitted tightly against a portion of the inner surface of the shell and the film is a continuous sheet that abuts the back reflector. Therefore, the back reflector is sandwiched between the outer shell and the optical lighting film.

These light waveguides disclosed in the prior art are constructed with a variety of cross-sectional shapes using a variety of materials including transparent dielectric materials such as acrylic plastic or optically clear glass, or multiplayer optical films.

In certain applications, however, instead of propagating the light as far as possible, the challenge is to reshape the light without increasing the geometrical size of the waveguide (e.g., shaping the light from a circular entrance beam to a required elliptical output). Thus, because current waveguide systems cannot significantly reshape the light without modifying the size of the system, it would be desirable to provide a waveguide capable of reshaping the light without increasing the size of the guide.

### SUMMARY OF THE INVENTION

It is an object of this invention to provide a waveguide including a longitudinal structure having a first end opposite a second end. A grooved surface is formed on the structure adjacent the first end.

It is further an object of this invention to provide a waveguide including a longitudinal structure having a first end opposite a second end. The waveguide further includes a grooved surface formed on the structure adjacent the first end. The geometric size of the longitudinal structure is substantially constant while the grooved surface reshapes a light input ray to decrease the divergence of the ray in a first direction and increase the divergence of the ray in a second direction.

It is yet another object of this invention to provide an illumination system to transmit an input light ray from a fiber optic source to a signboard display. The illumination system includes a collimating guide having a first end opposite a second end, and a longitudinal plank formed therebetween including a top surface and a bottom surface. A grooved surface is formed on the top surface and the bottom surface adjacent the first end.

### BRIEF DESCRIPTION OF THE DRAWINGS

A preferred exemplary embodiment of the invention is illustrated in the accompanying drawings in which like reference numerals represent like parts throughout, and in which:

FIG. 1A is a diagram illustrating an angular beam spread without the use of a lateral groove waveguide;

FIG. 1B is a diagram illustrating the anisotropic angular beam spread with the use of a lateral groove waveguide according to the present invention;

FIG. 2A is a diagram illustrating a collimating structure without a lateral groove waveguide;

FIG. 2B is a diagram illustrating a collimating structure with a lateral groove waveguide according to the present invention;

FIG. 3 is a elevated perspective view of a lateral groove waveguide according to the present invention;

FIG. 4 is a top view of the lateral groove waveguide according to the present invention;

FIG. 5 is an end view of the lateral groove waveguide according to the present invention;

FIG. 6 is a top planar view of the lateral groove waveguide according to the present invention;

FIG. 7 is a diagram of a ceiling display system according to the present invention;

FIG. 8 is a partial view of the groove structure of the lateral groove waveguide according to the present invention;

FIG. 9 is a diagram illustrating the reflection at the groove of the lateral groove waveguide according to the present invention;

FIG. 10 is a diagram illustrating the reflection without the lateral groove waveguide;

FIG. 11 is a diagram illustrating the reduction of the output angle using the lateral groove waveguide according to the present invention; and

FIG. 12 is a perspective view of a rectangular bar with the lateral groove waveguide according to the present invention.

### DETAILED DESCRIPTION OF PREFERRED EMBODIMENTS

Light directionality and beam collimation are essential for light shaping and display progress, in both imaging and non-imaging optics. The latter is important for backlighting and other light-shaping applications because only non-imaging optics can achieve the theoretical limit of maximum light collimation and concentration. In this regard, the beam collimation always comes at the expense of cross-section increasing.

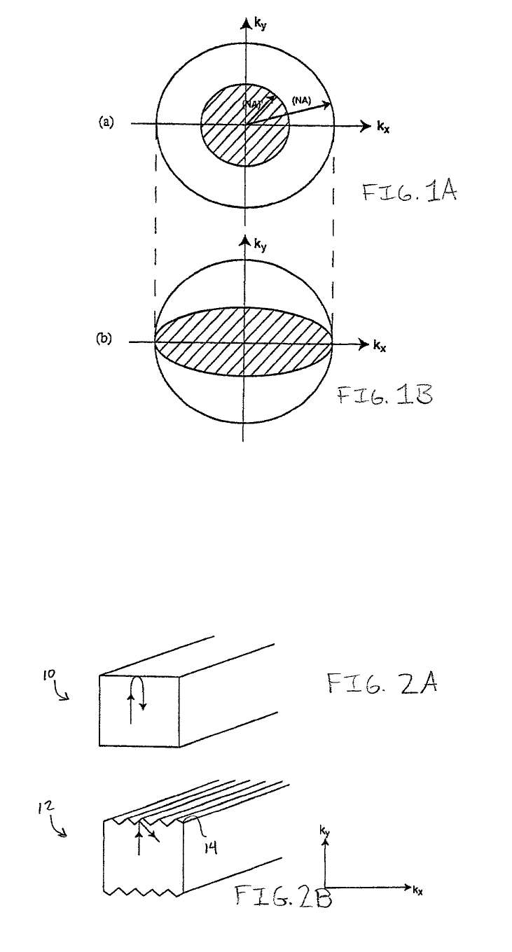

FIG. 1A illustrates an angular beam spread from NA′ to NA for the regular symmetrical waveguide. As illustrated in FIG. 1B, however, the beam can also spread anisotropically using a lateral groove waveguide structure resulting in anamorphic collimation to increase the beam directionality in the horizontal direction at the expense of the vertical direction (e.g., from a circle to an ellipse).

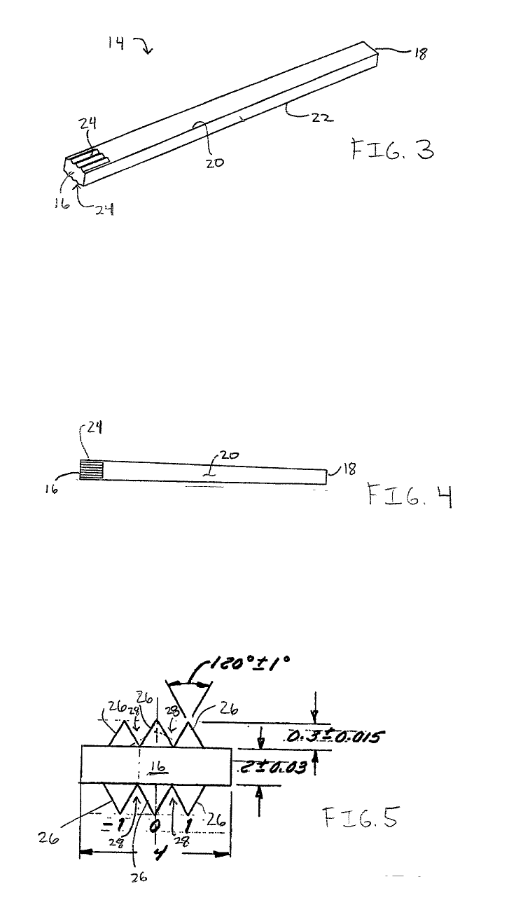

A collimating system 10 without a lateral groove waveguide is illustrated in FIG. 2A corresponding to the beam spread in FIG. 1A. A collimating system 12 with a grooved surface 14 corresponds to the horizontal beam spread illustrated in FIG. 1B.

As illustrated in FIG. 3, in the preferred embodiment of the present invention, a rectangular waveguide 14 includes a first end 16, a second end 18, a top surface 20, a bottom surface 22, and a groove portion 24 disposed adjacent first end 16. Guide 14 is generally decreasingly tapered in width from first end 16 to second end 18, for increasing horizontal divergence together with the groove structure. First end 16 is parallel to second end 18. Groove portion 24 is preferably formed on both top surface 20 and bottom surface 22.

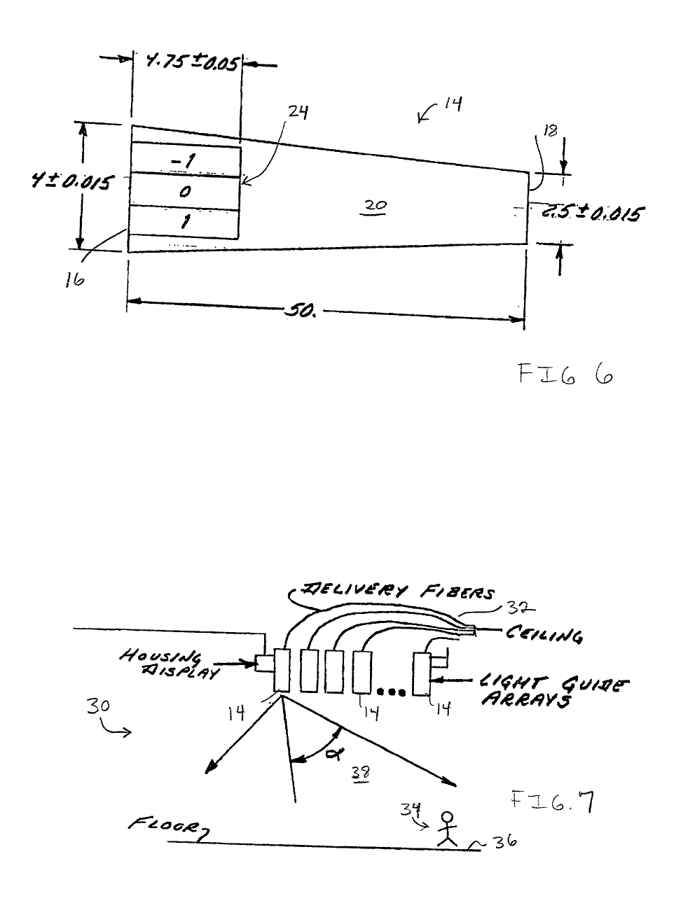

As illustrated in FIG. 5, groove portion 24 includes a series of generally triangular protrusions 26 (e.g., three protrusions on each surface 20 and 22) forming a series of grooves 28. In the present invention, the height of protrusions 26 is approximately 0.3 mm, the thickness of waveguide 14 is approximately 2 mm and the length of first end 16 is approximately 4 mm. As illustrated in FIG. 6, the length of second end 18 is approximately 2.5 mm, and the length of waveguide 14 from first end 16 to second end 18 is approximately 50 mm.

Waveguide 14 is formed from optically clear acrylic and input grooves 28 improve coupling efficiency and reduce output divergency in a vertical direction. Grooves 28 are placed at the entrance of waveguide 14 at first end 16 and therefore affect only high divergence input rays. The reflection at the inclined grooves' surface decreases the vertical divergence and increases the horizontal divergence of these rays. The taper provides a specific increasing light output divergence in the horizontal direction.

Waveguide 14 provides a means to input light energy from fiber optic sources for the purpose of delivering that light energy to a display. In the preferred embodiment of the present invention, waveguide 14 delivers light energy to a signboard display. In the alternative, waveguide 14 can deliver light energy to a variety of other displays including highway information displays (emergency announcements, traffic conditions, better signage for complex and dangerous intersections) and roadside advertising (electronic billboards).

Waveguide 14 may also be used in special illumination systems for theaters, convention/trade show areas, department stores, automobile showrooms and other public/semipublic areas that are enhanced by ceiling lighting that can be varied from high brightness in one area to low-level illumination in another area.

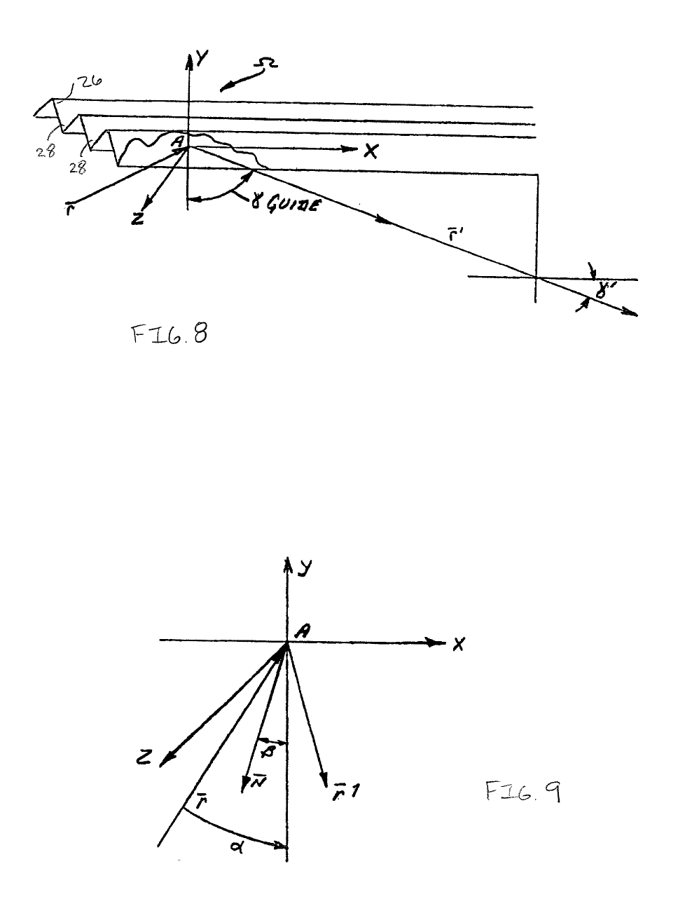

Turning to FIG. 7, a display system 30 is a ceiling display to deliver information and advertising to visitors in large halls, lobbies, and other facilities. System 30 includes waveguides 14 coupled to numerous delivery fibers 32 on the ceiling of a hall. A visitor 34 at a floor level 36 observes information from display system 30. To preserve the output brightness, light has to be concentrated in an observation sector 38, ±α through the lobby passway. In the preferred embodiment, the approximate value of α is ±50° and divergence in the orthogonal direction is ±20°.

Without the use of lateral groove waveguide 14 in system 30, the original divergence from the plastic fiber is ±30°. In order to increase the divergence up to ±50° in observation sector 38, the output size of waveguide 14 has to be reduced in this direction. In this regard, output size in that direction has to be increased in order to reduce divergence to ±20°. Unfortunately, there are limitations (e.g., packaging problems) that prevent an increase in the geometric size of waveguide 14.

Therefore, in order to reduce the divergence, grooves 26 are molded at the lateral size of waveguide 14. Grooves 26 thereby reshape the light without increasing the geometrical size of the waveguide 14.

In particular, FIG. 8 illustrates the effect of grooves 26 on the shape of the light. When light is incident to grooves 28, the angle between reflected ray, \overline{N}, and the axis, Y, increases. Hence, the outgoing divergence angle, γ¹, decreases. FIG. 9 illustrates this reflection of the incident ray at point A in greater detail.

Angle α is the angle between the axis, Y, and incident ray, \overline{N}. Angle β is the angle of the normal to the groove surface and axis Y in plane ZAY. Without the grooves, the angle β in FIG. 9 is 0. If \overline{x}, \overline{y}, \overline{z} are the eigen vectors of the axes,

\overline{r}=\overline{x}(sin α)+\overline{y}(cos α)+\overline{z}(0), and \overline{N}=\overline{x}(0)+\overline{y}(−cos β)+\overline{z}(sin β). (1-1)

The reflection law is

\overline{r′}=\overline{r}+\overline{N}(−2\overline{Nr}). (1-3)

The scalar product of Nr is (−cos αcos β).

Hence,

\overline{r′}=\overline{x}(sin α)+\overline{y}(cos α−2 cos²β cos α)+\overline{z}(2 sin β cos β cos α), (1-4)

or

\overline{r′}=\overline{x}(sin α)+\overline{y}(1−2 cos²β)cos α+\overline{z} cos+Z cos α·sin 2β). (1-5)

If β=0, or reflection takes place without the grooves, the reflected ray \overline{r′} is

\overline{r′}=\overline{x}(sin α)+\overline{y}(−cos α). (1-6)

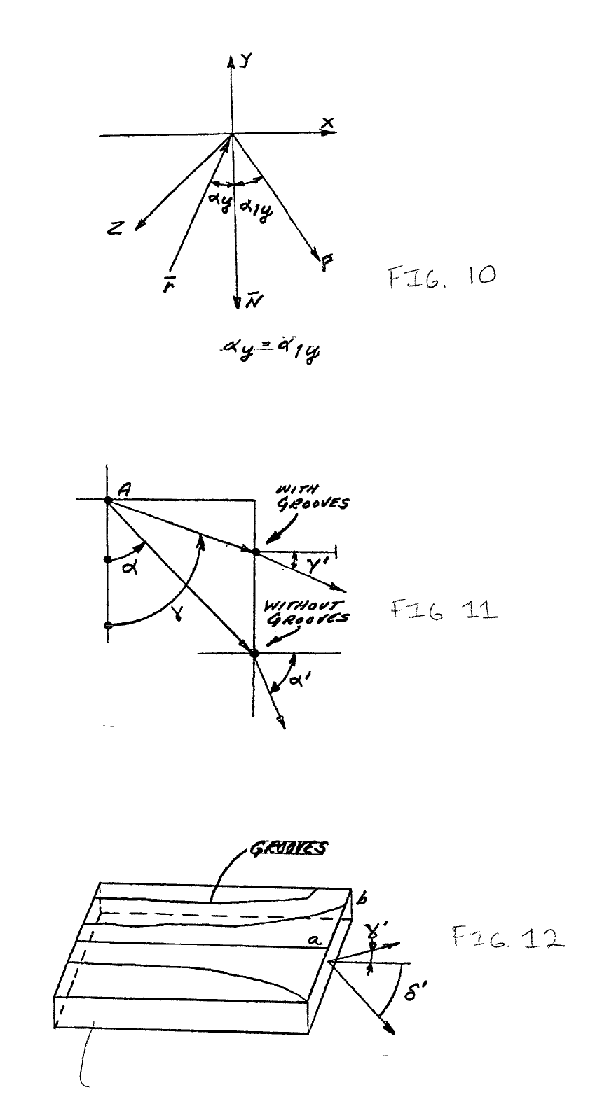

This is illustrated in FIG. 10 (reflection without lateral groove waveguide 14).

In the case of using lateral groove waveguide 14, however, the direct cosine of \overline{r′} with axis y is reduced to (1−2 cos²)cos α, and the angle, γ, in FIG. 8 and FIG. 11 is

γ=a cos[−(1−2 cos² β)cos α]. (1-7)

Hence,

γ>α. (1-8)

The output angle, γ′, in FIG. 8 is reduced as illustrated in FIG. 11.

FIG. 12 illustrates a rectangular acrylic bar 40 including lateral groove waveguide 14. For the optimal tradeoff between outgoing angles γ′ and δ′, the specific shape and geometry of grooves 28 may vary. In this regard, the geometry of grooves 28 is determined by angle β in FIG. 9. The shape of grooves 28 slightly increases the angle of divergence, δ′.

The scope of the application is not to be limited by the description of the preferred embodiments described above, but is to be limited solely by the scope of the claims that follow.

We claim:

1. A waveguide comprising:
a longitudinal structure having a first end opposite a second end, wherein a grooved surface is formed on a top surface and a bottom surface on the structure adjacent the first end.

2. The waveguide according to claim 1, wherein the grooved surface further includes a series of protrusions forming a groove therebetween.

3. The waveguide according to claim 2, wherein the protrusions are generally triangular.

4. The waveguide according to claim 1, wherein the longitudinal structure is formed from optically clear optical material.

5. The waveguide according to claim 2, wherein the groove reduces output divergency of a light input ray in one direction.

6. The waveguide according to claim 5, wherein the direction is a vertical direction.

7. The waveguide according to claim 6, wherein the groove increases horizontal divergency of the light input ray.

8. A waveguide comprising:
a longitudinal structure having a first end opposite a second end;
a grooved surface formed on the structure adjacent the first end; and
wherein the geometric size of the longitudinal structure is substantially constant while the grooved surface reshapes a light input ray to decrease the divergence of the ray in a first direction and increase the divergence of the ray in a second direction.

9. The waveguide according to claim 8, wherein the first direction is a vertical direction and the second direction is a horizontal direction.

10. The waveguide according to claim 9, wherein the grooved surface further includes a plurality of protrusions forming a groove therebetween.

11. The waveguide according to claim 10, wherein each of the protrusions includes an inclined surface.

12. The waveguide according to claim 8, wherein the longitudinal structure is formed from optically clear material.

13. The waveguide according to claim 8, wherein the grooved surface is formed on a top surface and a bottom surface of the longitudinal structure.

14. An illumination system to transmit an input light ray from a fiber optic source to a signboard display comprising:
a collimating guide having a first end opposite a second end, and a longitudinal plank formed therebetween including a top surface and a bottom surface; and
a grooved surface formed on the top surface and the bottom surface adjacent the first end.

15. The illumination system according to claim 14, wherein the geometric size of the longitudinal plank is substantially constant while the grooved surface reshapes the input light ray to decrease the divergence of the ray in a first direction and increase the divergence of the ray in a second direction.

16. The waveguide according to claim 15, wherein the first direction is a vertical direction and the second direction is a horizontal direction.

17. The waveguide according to claim 14, wherein the grooved surface further includes a plurality of protrusions forming a groove therebetween.

18. The waveguide according to claim 17, wherein each of the protrusions includes an inclined surface.

19. The waveguide according to claim 14, wherein the longitudinal plank is formed from optically clear material.

20. The waveguide according to claim 18, wherein each of the protrusions is generally triangular.
